(19) United States
(12) Patent Application Publication
(10) Pub. No.: US 2005/0252846 A1
(43) Pub. Date: Nov. 17, 2005

(54) Method for joining thin sheet-type sintered metal elements, and filter body produced therefrom

(76) Inventors: Hermann-Josef Schulte, Menden (DE); Jochen Koll, Amsberg (DE)

Correspondence Address: RONALD S. LOMBARD;PATENTS AND TRADEMARKS, 4430 TWIN OAKS DRIVE, MURRYSVILLE, PA, 15668, US

(21) Appl. No.: 11/157,674

(22) Filed: Jun. 21, 2005

(30) Foreign Application Priority Data
Jan. 13, 2003 (DE) 103 01 033.5

(51) Int. Cl. B01D 25/00

(52) U.S. Cl. 210/323.1; 210/499; 432/1; 266/44

(57) ABSTRACT

A method for joining sinter metal elements comprising a carrier sheet having openings filled with a sinter metal for the construction of a sinter metal filter element or sinter metal filter body is disclosed. At least two sinter metal elements having pores for the passage of a fluid to be filtered are disposed adjacent one another and joined along an end section thereof by first introducing fine particles into the pores of the sinter metal elements in an area adjacent to the end sections of the sinter metal elements to be joined, so as to close the pores in that area, and the end sections of the sinter metal filter elements are then joined by heating with a joining material which, upon heating melts and enters the pores of the end section of the sinter metal elements but not the blocked pores in the adjacent area. A filter body produced therefrom is also disclosed.

### CROSS-REFERENCE TO RELATED APPLICATION

This is a continuation-in-part of international application PCT/EP 2004/000158 filed Jan. 13, 2004 and claiming the priority of German application 103 01 033.5 filed Jan. 13, 2003.

### BACKGROUND OF THE INVENTION

This invention resides in a method for joining thin metal sheet-like sinter metal elements formed from a carrier having openings filled with a sinter metal for producing a sinter metal filter element and/or a sinter-metal filter body. Furthermore, the invention resides in a sinter metal filter body with filter pockets which are closed at the upstream or downstream end by joining adjacent elements, the filter body being manufactured from such sinter metal filter elements.

Thin metal sheet-like sinter metal elements are for example sinter metal strip or sheets. They are used in order to manufacture therefrom filter elements or filter bodies for exhaust gas particle filters. The sinter metal filter material comprises a carrier of metal with openings which are filled with a sinter metal powder and have been subjected to a sintering process. A carrier, generally wire fabric or expanded metal sheets, is used. Such sinter metal sheets or strips are used for the manufacture of exhaust gas particle filters since, with the metallic structure of the sinter metal sheets a filter body manufactured therefrom can not only withstand the high temperatures of the exhaust gas flow, but also the much higher temperatures generated during the regeneration of such filter bodies with the burning off of the carbon deposits. For the manufacture of such a filter body as it is known for example from WO 02/102494 A1, individual filter pockets are formed by canting such sinter metal sheets or strips. For closing these cantered filter pockets, it is necessary to join a longitudinal and a front side of the filter metal strip. In a known filter body, the filter pockets become wedge-like narrower in a radial direction and also in the direction of the longitudinal axis of the filter body, so that the fine filter pocket wall sections to be joined are disposed adjacent one another at the narrower end of such a filter pocket. The filter pocket walls are joined to form the filter pocket generally by roller seam welding. This can be done without problems since the filter pocket wall sections disposed on one another can be moved for this joining through the roller gap of a roller seam welding apparatus without any problems.

For forming the actual filter bodies a multitude of such pre-finished filter pockets are arranged radially around a support tube. For closing the filter body or, respectively, separating the clean side from the soot-laden side (soot side) the abutting wall sections of the one-sided open filter pockets must be joined. Since the opening widths of the pockets is only a few millimeters and the gap between the filter walls becomes smaller toward the radially inner end, the joint can not be established by roller seam welding. It has therefore been tried to join the adjacent walls of the filter pockets by melt-welding. However, satisfactory welding results could not be obtained; uniform welding seams could not be formed. The same result was obtained in attempts to join the filter pocket walls by a soldering process.

Based on the state of the art as discussed above it is the object of the present invention to provide a method for joining thin sheet sinter metal elements and to provide a filter body manufactured therefrom wherein the sinter metal sheet sections are firmly joined without encountering the disadvantages discussed above in connection with the known state of the art.

### SUMMARY OF THE INVENTION

A method for joining sinter metal elements comprising a carrier sheet having openings filled with a sinter metal for the construction of a sinter metal filter element or sinter metal filter body is disclosed. At least two sinter metal elements having pores for the passage of a fluid to be filtered are disposed adjacent one another and joined along an end section thereof by first introducing fine particles into the pores of the sinter metal elements in an area adjacent to the end sections of the sinter metal elements to be joined, so as to close the pores in that area, and the end sections of the sinter metal filter elements are then joined by heating with a joining material which, upon heating melts and enters the pores of the end section of the sinter metal elements but not the blocked pores in the adjacent area. A filter body produced therefrom is also disclosed.

In the method according to the invention, before the joining of the sinter metal sheets, the porosity of the sinter metal elements is reduced in those areas which are adjacent the sections to be joined. In connection with the filter body this is the material area adjacent the jointures for closing the pockets. The porosity is reduced in those areas by the introduction of fine particles into the pore spaces of these material areas for example by a sedimentation process. The open pore spaces of the area to be joined however remain basically empty. As a result, the material added during the joining procedure can enter only into the pores of the area of jointure. The material introduced for the joining procedure can therefore not be sucked off into the adjacent areas by capillary action. The porosity of the sinter metal elements in the areas to be joined is utilized so that material added for the joining procedure, for example solder, enters into the pores of the areas to be joined. On one hand, in this way a better engagement of the soldering material with the sinter metal element is achieved. On the other hand, with the penetration of the material added during the joining procedure into the pores of the area being joined it is assured that the added material comes into contact with the metallic carrier of the sinter metal element and is joined thereto. Consequently, the connection between the areas of the sinter elements to be joined by the added material, for example the solder, is substantially stronger than in a connection where the added material is connected only to the exposed sides of the metal parts to be joined.

The particles used for the reduction of the porosity are naturally of very fine grain, that is substantially smaller than the average pore size of the sinter element and have a temperature resistance so that they are not detrimentally affected by the temperature to which they are subjected during the joining procedure; that is they should not melt and open again the pores closed by the particles. As particles, for example, inorganic ceramic particles and/or so called nano-particles can be used. Basically, all particles or particle mixtures can be used for the reduction of the porosity in which can be introduced into the pores, which are retained therein and which are capable of withstanding the temperatures occurring during the joining procedure.

The particles can be introduced with the aid of a liquid by a sedimentation process. Such a sedimentation process can mechanically be aided wherein the particles contained in the suspension are brushed into the pores by mechanical elements. It is advantageous to employ a binder by which the particles are attached to one another and to the pore walls after the liquid has evaporated. The binder does not need to be temperature resistant since during jointure the particles introduced into the pores will not be driven out of the pores so that the added joining material such as solder, cannot enter the pores occupied by the particles.

For reinforcement of the areas to be joined or certain areas of the sinter metal element, it may be expedient to strengthen the area to be joined by an increased material thickness for example by simple or multiple bending over the sections to be joined about bending axes which extend parallel to the edge of the sections. In addition a material strip may be inserted into the bent section for reinforcement.

For procedural reasons the material sections adjacent the areas of jointure which have a reduced pore volume extend for a certain distance from the area of jointure. Following the section with the filled pores there are the sections of the sinter element which represent the filter walls of a filter body which are effective for filtering. After the jointure of the filter walls, the wall areas with reduced pore volume form a transition area with respect to the rigidity of the joined elements. The transition area is less rigid then the joined areas or sections of the sinter element because the pores are filled with particles but they are stiffer than the remaining sections of the sinter metal element. With this transition area, a filter body formed from such sinter metal elements will have a long operating life even with exposure to vibrations as they are generally present in the exhaust gas duct of an internal combustion engine.

As joining processes for performing the method according to the invention basically welding or soldering procedures can be used.

### BRIEF DESCRIPTION OF THE DRAWINGS

For a better understanding of the invention reference may be had to the accompanying drawings exemplary of the invention, in which:

FIG. 1 is a schematic cross-sectional view of the sinter metal element in a section adjacent the area to be joined;

FIG. 2 shows the sinter metal element of FIG. 1 with the pores of part of the section filled with particles; and,

FIG. 3 shows schematically a longitudinal cross-section of a filter body of an exhaust gas particle filter manufactured from the sinter elements shown in FIG. 2 joined at opposite ends.

### DESCRIPTION OF THE PREFERRED EMBODIMENTS

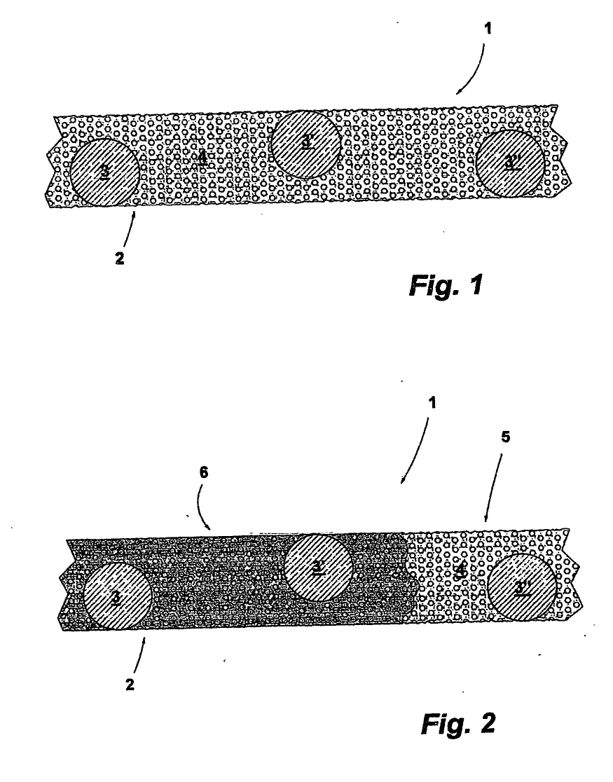

A thin metal sheet-like sinter metal element 1 comprising a carrier 2 of a wire fabric for example of which three wires 3, 3′, 3″ are visible in the cross-section of FIG. 1. The loops of the wire fabric serving as carrier 2 are filled with a sinter metal 4. The sinter metal 4 introduced into the loops or mesh in the form of sinter metal powder and then subjected to a sintering process so that the individual particles of the sinter metal powder are joined together and to the wire mesh. The sinter metal 4 is shown in the figures in a highly schematic manner. The sinter metal 4 itself is porous and has a pore space of about 50%.

The sinter metal element 1 shown in FIG. 1 is to be joined at its right side end to another corresponding sinter metal element. In the embodiment described herein a soldering procedure is used for the joining. Before the sinter metal element 1 is joined at it right end of FIGS. 1 and 2 with the additional sinter element by the soldering procedure the sections of the sinter metal element 1, and the corresponding section of the additional sinter element, which are disposed adjacent the sections 5 to be joined, that is, the sections of the filter element which are not to be joined next to the sections to be joined are pretreated in order to achieve a certain soldering result. During this pretreatment the pores of the sinter element 1 in the area 6 adjacent to the section 5 to be joined are filled with inorganic ceramic nano particles to such an extent that a capillary induction of the soldering material into the pores of section 6 is avoided during the soldering of the section 5.

The nano particles provided for the filling of the pores are introduced into the pores of the material area designated by the reference numeral 6 by precipitation from a liquid medium in which the nano particles are suspended. The suspension also includes a binder for allowing the particles introduced into the pores to bind to one another and also to the pore walls.

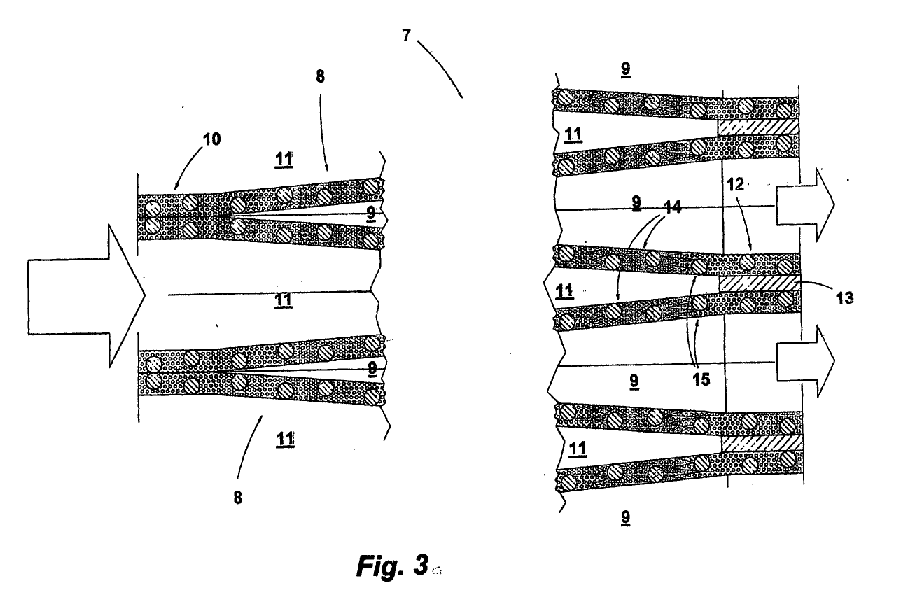

FIG. 3 shows a filter body 7 of an exhaust gas particle filter for removing soot from the exhaust gas of a Diesel internal combustion engine. The filter body 7 consists of a multitude of individual pocket-like sinter metal filter elements 8, which again are formed from sinter metal elements corresponding to those shown in FIGS. 1 and 2. The sinter metal filter elements 8 are arranged in the shown embodiment in a radial arrangement as is known for example from WO 02/102 494 A1. The flow direction of the exhaust gas through the filter body 7 is indicated by the block arrows in FIG. 3. The sinter metal filter elements 8 enclose in each case a pocket like hollow space 9 which extends radially inwardly from the outside and becomes narrower toward the exhaust gas inlet end where the two adjacent metal filter elements 8 are joined are joined by roller welding. The closed end of the hollow space 9 is indicated in FIG. 3 by the reference numeral 10. The walls of the sinter metal filter elements 8 form the filter walls through which the exhaust gas passes.

For the separation of the soot laden filter side of the filter body 7, formed by the inflow side surface area 11, from the clean side the respective adjacent downstream end areas of two adjacent sinter metal filter elements 8 are joined to one another. This joint area between two sinter metal filter elements 8 is designated in FIG. 3 by the reference numeral 12. Between the two sections of the sinter filter elements 8 defining the joint area 12, a solid material strip 13 is arranged. The solid material strip 13 is provided to increase the stability of the filter body 7 at the downstream end thereof. Furthermore, the solid material strip 13 provides for a space between the filter walls at the soot collection side of the filter body 7 for forming an ash collection space at the downstream end of the inflow area 11. The filter body 7 is supported in a housing which is not shown in the figures, but which is provided with a flange at the downstream end. The pores of the end areas 14 of this sinter metal filter elements 8 adjacent the joint sections 12 are filled with particles as described for this sinter metal element 1 described in connection with FIG. 1. In this way it is prevented that during the joining of the sinter metal filter elements 8 the material added in the joint section 12 is sucked out of the joint section as a result of the porosity of the adjacent sinter metal material. The end sections of the sinter metal sheets to be joined are preferably bent over at least one before they are joined so as to increase their thickness in the joint area. They are bent parallel to the end edge of the metal filter element, not shown. This results in reinforcement of the jointure.

The joining of the sinter metal filter elements 8 in the area of the joint sections 12 is achieved by a soldering process. The joint area 12 is shown in FIG. 3 without identification symbol for the particular joining procedure. With the soldering procedure the joint area 12 becomes relatively rigid, particularly if a reinforcement strip 13 of a solid material is used. This is desirable in order to provide for the filter the necessary stability at the downstream end thereof. The area between the actual joint area and the filled-pore material area 14 may be designated as a transition area 15. This transition area 15 is characterized by the induction of only a small amount of solder material as compared with the amount absorbed by the joint area 12. The transition area 15 is formed in a particular way as an accurate delimitation of the area 14 with the filled pores and does not have the material rigidity of the sinter metal filter element 8 in area 14. The rigidity of this transition area 15 is less than the rigidity of the joint area because of the smaller amount of solder induced in this area. Still the rigidity of this area 15 is greater than that of the sinter filter element 8 in the other wall sections which form the actual filter wall sections. Consequently, the area 15 forms, as far as rigidity is concerned, a transition area between the joint areas 12 and the other sections of the sinter metal filter element 8. This substantially contributes to a relatively long life for the filter body, particularly in connection with its use in a vibration environment as it is present in the exhaust gas duct of an internal combustion engine.

1. A method for joining sinter metal elements (1) comprising a carrier sheet having openings filled with a sinter metal for the construction of a sinter metal filter element (8) of a sinter metal filter body (7), said method comprising the steps of: providing at least two of said sinter metal elements having pores for the passage of a fluid to be filtered, introducing fine particles to fill the pores of the sinter metal elements (1) in an area (6) adjacent an end section (5) of the sinter metal elements (1) where the two sinter metal elements (1) are to be joined, said particles being resistant to temperatures occurring during the subsequent joining, and joining the two sinter metal elements (1) at the end sections (5) where the pores have not been filled by heating with a joining material supplied to the joint area which, upon heating becomes liquid and enters the pores of the sinter metal elements so as to form a firm connection therebetween.

2. The method according to claim 1, wherein the fine particles are introduced into the pores by a suspension of the fine particles applied to the area (6) of the sinter metal elements (1).

3. The method according to claim 2, wherein the particle suspension includes a binder which is introduced into the pores together with the particles so that, upon drying of the suspension, the particles are attached to one another and also to the pore walls.

4. The method according to claim 1, wherein the fine particles for filling the pores are inorganic ceramic particles.

5. The method according to claim 1, wherein the end section (5) of the sinter metal elements (1) to be joined are thickened before they are joined.

6. The method according to claim 5, wherein the end sections of the sinter metal sheets to be joined are bent over at least once before they are joined so as to increase their thickness in the area of jointure.

7. The method according to claim 1, wherein a strip (13) of a solid non-porous material is placed between the sinter metal sheet sections (5) to be joined for increasing the strength of the joined sections (5) of the sinter metal sheets (1).

8. The method according to claim 1, wherein the sinter metal sheet sections (5) are joined by a soldering procedure.

9. A sinter metal filter body including filter pockets formed by sinter metal filter elements which are joined at opposite ends with adjacent sinter metal filter elements, said sinter metal filter elements comprising each a carrier member provided with a sinter material having pores, and the pores in an area adjacent an end section of the sinter metal filter elements where the elements are joined being filled with particles as to close the pores in the area adjacent to the end section, adjacent end sections of the metal filter elements being joined by a joining material.

10. The sinter metal filter body according to claim 9, wherein the end section of the sinter metal filter elements are bent over at least once parallel to the end edge of the metal filter element for reinforcement of the jointure.

11. The sinter metal filter body according to claim 9, wherein a metal strip (13) of a non-porous solid material is disposed in the joint area between the adjacent two sinter metal filter elements for increasing the strength and rigidity of the joint and provide a certain distance between the joined sinter metal filter elements.
